(19) United States
(12) Patent Application Publication
(10) Pub. No.: US 2008/0313501 A1
(43) Pub. Date: Dec. 18, 2008

(54) METHOD AND SYSTEM FOR ASSESSING AND ANALYZING SOFTWARE RELIABILITY

(75) Inventors: CHU TI LIN, CHANGHUA COUNTY (TW); CHIN YU HUANG, TAIPEI COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU CITY (TW)

(21) Appl. No.: 12/013,300

(22) Filed: Jan. 11, 2008

Related U.S. Application Data
(60) Provisional application No. 60/943,956, filed on Jun. 14, 2007.

(51) Int. Cl. G06F 11/00

(52) U.S. Cl. 714/38; 714/E11.028

(57) ABSTRACT

A method for assessing and analyzing software reliability comprises the steps of: collecting failure data from a software system during a testing period; providing a reliability model having a testing compression factor, wherein the reliability model is used to fit the failure data; providing an estimation function derived from the reliability model; obtaining the value of the testing compression factor in accordance with the estimation function; and using the testing compression factor to determine the efficiency of test cases.

### BACKGROUND OF THE INVENTION

1. Field of the Invention

The present invention relates to a method and system for assessing and analyzing software reliability, and more particularly, to a method and system for assessing and analyzing software reliability with a reliability model having a testing compression factor.

2. Description of the Related Art

In recent years, due to the growing significance of software applications, professional testing of software has become an increasingly important task. The dependency between faults may exist. For example, as shown in FIG. 1, the path selection made in line 32 (S₂) depends on the definition of the variable loop in S₁. That is, the definition of the loop in line 15 will determine the execution times of S₃ and then affect the value of count while escaping from line 51. It is noted that line 66 will not print out the expected message unless the fault of the program in S₄ is corrected, i.e., “++” should come after “count.” In addition, the faulty definition of loop in line 51 will cause the unexpected value of count. Thus, in addition to removing the fault in S₄, it is necessary to correct the leading fault in S₁, which shows the 1-to-many mapping between failures and faults in the program.

Software reliability has important relations with many aspects of software, including the structure, the operational environment, and the amount of testing. In fact, software reliability analysis is a key factor of software quality and can be used for planning and controlling the testing resources during development. Over the past three decades, many software reliability growth models have been proposed. For most traditional software reliability growth models, one common assumption is that the fault detection rate is a constant over time. However, the fault detection process in the operational phase is different from that in the testing phase.

### SUMMARY OF THE INVENTION

The present invention proposes a method for assessing and analyzing software reliability, and one embodiment of the method comprises the steps of: collecting failure data from a software system during a testing period; providing a reliability model having a testing compression factor, wherein the reliability model is used to fit the failure data; providing an estimation function derived from the reliability model; obtaining the value of the testing compression factor in accordance with the estimation function; and using the testing compression factor to determine the efficiency of test cases.

Another embodiment of the present invention comprises the steps of: collecting failure data from a software system during a testing period; providing a reliability model having a testing compression factor, wherein the reliability model is used to fit the failure data; providing an estimation function derived from the reliability model; obtaining unknown values of parameters of the reliability model in accordance with the estimation function; and using the parameters to analyze the software reliability.

The software testing system according to one embodiment of the present invention includes a reliability model, which has a reliability model with a testing compression factor, wherein the reliability model includes a validation phase, a field trial phase and an operation phase, and the testing compression factor is used to evaluate the characteristic of the field trial and operation phases.

### BRIEF DESCRIPTION OF THE DRAWINGS

The invention will be described according to the appended drawings in which:

FIG. 1 shows a faulty program;

FIGS. 2A and 2B show a selected real data set;

FIG. 3 shows RE curves; and

FIG. 4 shows a flow chart according to one embodiment of the present invention.

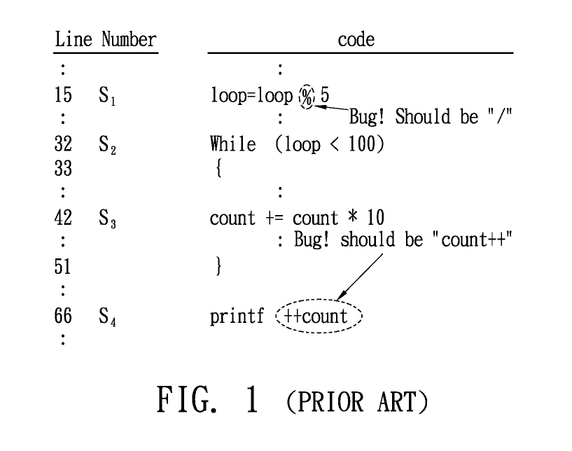

### PREFERRED EMBODIMENT OF THE PRESENT INVENTION

Normally, the testing period includes three phases, i.e., validation, field trial and operation. The reliability model of one embodiment of the present invention is expressed as follows:

$$\{ \begin{matrix}{m}_{1} ( t ) = ( a / α ) \times ( 1 - exp [ - r α t ] ) , & 0 \leq t < τ , \\ {m}_{2} ( t ) = ( a / α ) \times ( 1 - exp [ - r α ( \frac{t - τ}{c} + τ ) ] ) , & t \geq τ .\end{matrix}$$

Wherein m₁(t) represents the validation phase characteristic, m₂(t) represents the field trial and operation phase characteristic, the parameter α represents a quantified ratio of faults to failures in the software system, τ represents a change point when the validation phase ends, the parameter α represents the expected number of initial faults, the parameter c represents the testing compression factor used to determine the efficiency of test cases during the test period, and the parameter r represents a fault detection rate during the validation phase.

Unknown parameters of the reliability model can be obtained by an estimation function, like Maximum Likelihood Estimation (MLE) or Least Square Estimation (LSE). Here, MLE is taken as an example. First, a likelihood function L is sought.

$$\begin{matrix}L = {\prod }_{i = 1}^{n} \frac{{[ m ( {t}_{i} ) - m ( {t}_{t - 1} ) ]}^{( {y}_{i} - {y}_{i - 1} )}}{( {y}_{i} - {y}_{i - 1} ) !} exp [ - ( m ( {t}_{i} ) - m ( {t}_{i - 1} ) ) ] \\ = exp [ - m ( {t}_{n} ) ] \times {\prod }_{i = 1}^{n} \frac{{[ m ( {t}_{i} ) - m ( {t}_{i - 1} ) ]}^{( {y}_{i} - {y}_{i - 1} )}}{( {y}_{i} - {y}_{i - 1} ) !}\end{matrix}$$

Second, the likelihood function L is differentiated by each unknown parameter, and the partial derivatives are set to zero, where m(t) is the expected number of faults during (0, t) and y is the actual number of faults during (0, t).

$$\frac{L}{\partial a} = \frac{L}{\partial r} = \frac{L}{\partial α} = \frac{L}{\partial c} = 0$$

Third, the nonlinear equations are solved.

When the operational profile is not fully developed, the application of a testing compression factor (TCF) can assist in estimating field reliability. A TCF is defined as the ratio of execution time required in the operational phase to execution time required in the test phase to cover the input space of the program. Since testers during testing are quickly searching through the input space for both normal and abnormal execution conditions, while users during operation only execute the software with a regular pace, this factor represents the reduction of failure rate (or increase in reliability) during operation with respect to that observed during testing. For example, assuming that the number of input spaces of a software program is 1000, if a programmer elaborately designs test cases, which can fully cover the input spaces of the software by taking only ten days in contrast with manual operation taking fifty days, the TCF factor will be 50/10=5. In other words, the more efficient the test cases are, the higher the factor TCF is. Consequently, the factor TCF can be used to evaluate the efficiency of the test cases.

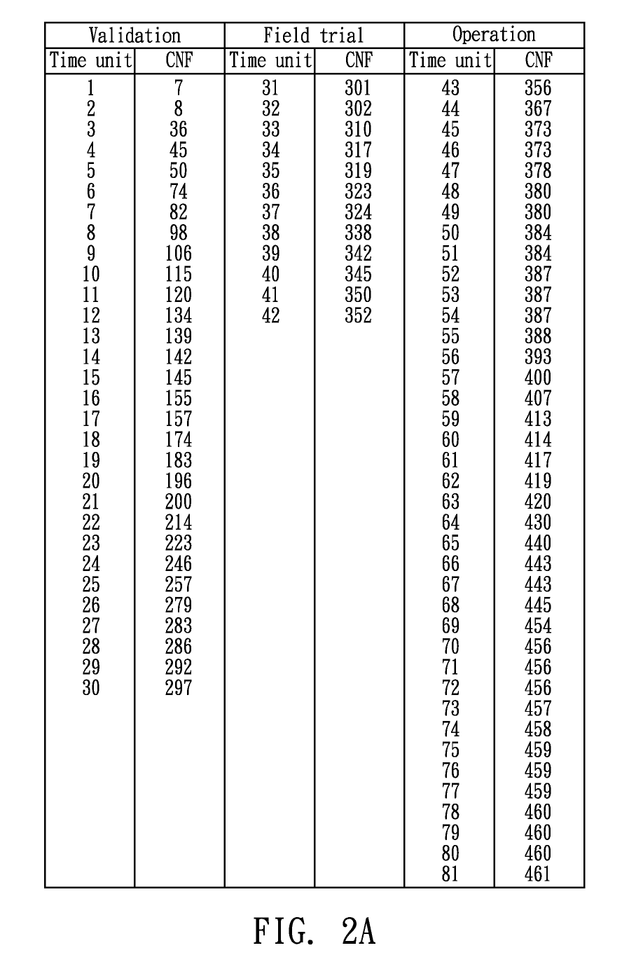

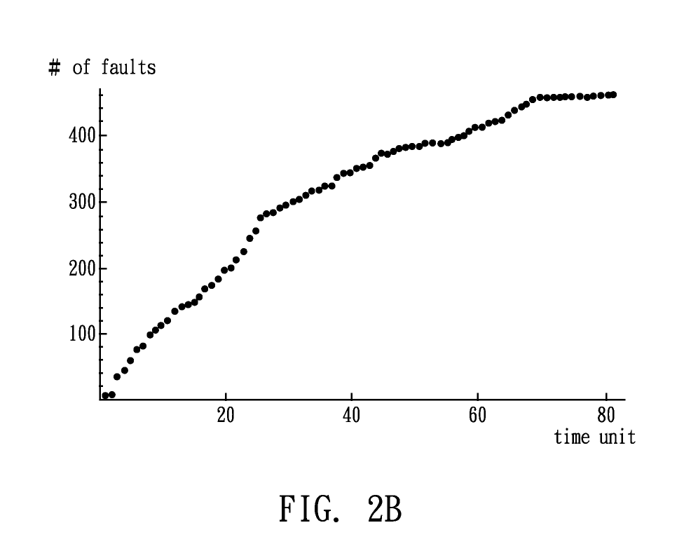

As shown in FIG. 2A, a real data set is selected from a Brazilian Electronic Switching software system. The collection of this widely-used data set was conducted throughout the above-mentioned phases. Because the transition from validation phase to field trial phase can be viewed as a change point (e.g., when τ is equal to 31), thus the proposed model can be applied to this data set. The number of failures was counted per time unit of ten days. The software system was employed in validation phase during the first 30 time units and then was under field trial phase until the 42^{nd} time unit. During 42 time units of testing, 352 faults were removed. Moreover, another 108 corrections were made during the first year of operation, i.e., from the 43^{rd} time unit to the 81^{st} time unit. FIG. 2B shows the corresponding testing result.

The failure data collected during the validation phase and field trail phase are used to estimate the parameters and then use the estimates to forecast the operational failure data. Table I gives the estimated parameters of the present invention and other known models, and the performance comparisons are shown in Table II, which includes the comparison of using 1-42, 43-81, and 1-81 time unit data.

TABLE I

| Model | a | r | Remark |
|---|---|---|---|
| Present Invention | 509.51 | 2.14 × 10⁻² | α = 3.23 × 10⁻¹, c = 1.98, |
| | | | τ = 31 |
| GO | 727.57 | 1.65 × 10⁻² | N/A |
| YSS | 382.06 | 9.34 × 10⁻² | N/A |
| OCID | 420.69 | 2.86 × 10⁻² | β = 4.22 × 10⁻¹ |

TABLE II

| | Mean Square Error | | | |
|---|---|---|---|---|
| | (MSE) | | Kolmogorov-Smirnov (KS) | |
| | 1^{st} to 42^{nd} | 43^{rd} to 81^{st} | 1^{st} to 42^{nd} | 43^{rd} to 81^{st} |
| Model | 1^{st} to 81^{st} time units | | 1^{st} to 81^{st} time units | |
| Present Invention | 63.96 | 402.24 | 5.02 × 10⁻² | 2.29 × 10⁻¹ |
| | 174.03 | | 9.09 × 10⁻² | |
| GO | 97.86 | 1258.70 | 8.91 × 10⁻² | 1.78 × 10⁻¹ |
| | 656.79 | | 1.28 × 10⁻¹ | |
| YSS | 238.18 | 2327.67 | 8.94 × 10⁻² | 3.30 × 10⁻¹ |
| | 1244.23 | | 1.60 × 10⁻¹ | |
| OCID | 97.86 | 1258.70 | 8.91 × 10⁻² | 1.78 × 10⁻¹ |

| | |
|---|---|
| 656.79 | 1.28 × 10⁻¹ |

As shown in Table II, the present invention has the lowest MSE and KS values. Consequently, the present invention gives a good fit to the failure data during the testing phase.

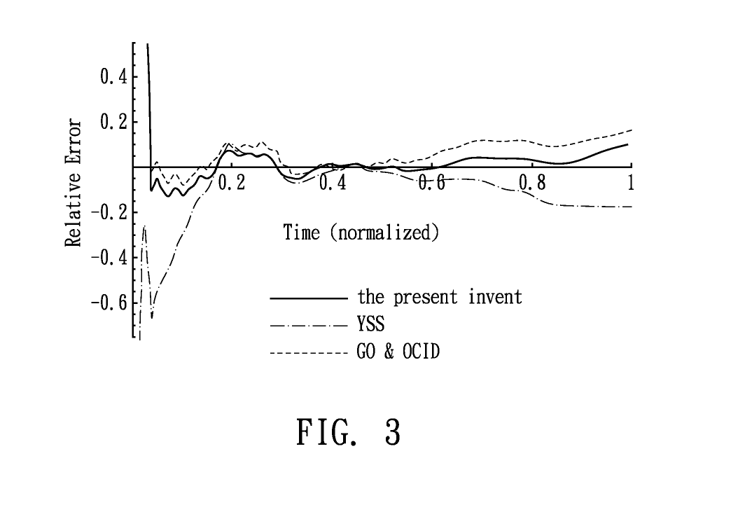

FIG. 3 shows RE curves. It is obvious that the present invention gives the slightest bias during operation. On the whole, the present invention not only fits the testing failure data well but also provides an outstanding prediction capability on the operational phase.

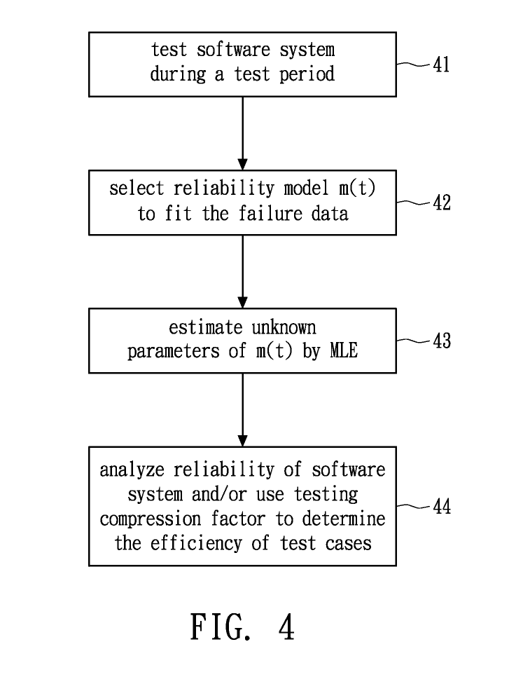

FIG. 4 shows a flow chart according to one embodiment of the present invention. In Step 41, the software testing during a testing period is initiated. In Step 42, a reliability model m(t) is selected to fit the failure data. In Step 43, unknown parameters such as a, r, α are estimated by MLE. Particularly, through partial derivative, the parameters are obtained. In Step 44, the efficiency of the test cases and/or the reliability of the software system is analyzed by using factor TCF.

The above-described embodiments of the present invention are intended to be illustrative only. Numerous alternative embodiments may be devised by persons skilled in the art without departing from the scope of the following claims.

What is claimed is:

1. A method for assessing and analyzing software reliability, the method comprising the steps of:
collecting failure data from a software system during a testing period;
providing a reliability model having a testing compression factor, wherein the reliability model is used to fit the failure data;
providing an estimation function derived from the reliability model;
obtaining the value of the testing compression factor in accordance with the estimation function; and
using the testing compression factor to determine the efficiency of test cases.

2. The method of claim 1, wherein the selecting step comprises the step of:
collecting failure data from the software system during a validation phase of the testing period.

3. The method of claim 1, wherein the estimation function is one of maximum likelihood estimation and least square estimation.

4. The method of claim 1, wherein the obtaining step takes a partial derivative upon the estimation function to zero.

5. The method of claim 1, wherein the reliability model includes a validation phase, field trial phase and operation phase, and the testing compression factor is used to evaluate the characteristic of the field trial and operation phases.

6. The method of claim 5, wherein the characteristics of the reliability model are affected by parameters a and r, wherein the parameter a represents the expected number of initial faults and the parameter r represents a fault detection rate during the validation phase.

7. The method of claim 5, wherein the software reliability model is expressed as:
$$\{ \begin{matrix}{m}_{1} ( t ) = ( a / α ) \times ( 1 - exp [ - r α t ] ) , & 0 \leq t < τ , \\ {m}_{2} ( t ) = ( a / α ) \times ( 1 - exp [ - r α ( \frac{t - τ}{c} + τ ) ] ) , & t \geq τ ,\end{matrix}$$
wherein m₁(t) represents the validation phase characteristic, m₂ (t) represents the field trial and operation phase characteristic, the parameter α represents a quantified ratio of faults to failures in the software system, the parameter c represents a testing compression factor, the parameter a represents the expected number of initial faults, the parameter r represents a fault detection rate during the validation phase, and τ represents a change point when the validation phase ends.

8. A method for assessing and analyzing software reliability, comprising the steps of:
collecting failure data from a software system during a testing period;
providing a reliability model having a testing compression factor, wherein the reliability model is used to fit the failure data;
providing an estimation function derived from the reliability model;
obtaining unknown values of parameters of the reliability model in accordance with the estimation function; and
using the parameters to analyze the software reliability.

9. The method of claim 8, wherein the selecting step comprises the step of:
collecting failure data from the software system during a validation phase of the testing period.

10. The method of claim 8, wherein the estimation function is one of maximum likelihood estimation and least square estimation.

11. The method of claim 8, wherein the obtaining step takes a partial derivative upon the estimation function to zero.

12. The method of claim 8, wherein the reliability model includes a validation phase, field trial phase and operation phase, and the testing compression factor is used to evaluate the characteristic of the field trial and operation phases.

13. The method of claim 12, wherein the characteristics of the reliability model are affected by parameters a and r, wherein the parameter a represents the expected number of initial faults and the parameter r represents a fault detection rate during the validation phase.

14. The method of claim 8, wherein the software reliability model is expressed as:
$$\{ \begin{matrix}{m}_{1} ( t ) = ( a / α ) \times ( 1 - exp [ - r α t ] ) , & 0 \leq t < τ , \\ {m}_{2} ( t ) = ( a / α ) \times ( 1 - exp [ - r α ( \frac{t - τ}{c} + τ ) ] ) , & t \geq τ ,\end{matrix}$$
wherein m₁(t) represents the validation phase characteristic, m₂ (t) represents the field trial and operation phase characteristic, the parameter α represents a quantified ratio of faults to failures in the software system, the parameter c represents a testing compression factor, the parameter a represents the expected number of initial faults, the parameter r represents a fault detection rate during the validation phase, and τ represents a change point when the validation phase ends.

15. A software testing system having a reliability model with a testing compression factor, wherein the reliability model includes a validation phase, a field trial phase and an operation phase, and the testing compression factor is used to evaluate the characteristic of the field trial and operation phases.

16. The software testing system of claim 15, wherein the characteristics of the reliability model are affected by parameters a and r, wherein the parameter a represents the expected number of initial faults, and the parameter r represents a fault detection rate during the validation phase.

17. The software testing system of claim 16, wherein the software reliability model is expressed as:
$$\{ \begin{matrix}{m}_{1} ( t ) = ( a / α ) \times ( 1 - exp [ - r α t ] ) , & 0 \leq t < τ , \\ {m}_{2} ( t ) = ( a / α ) \times ( 1 - exp [ - r α ( \frac{t - τ}{c} + τ ) ] ) , & t \geq τ ,\end{matrix}$$
wherein m₁(t) represents validation phase characteristic, m₂ (t) represents field trial and operation phase characteristic, the parameter of α represents a quantified ratio of faults to failures in the software testing system, the parameter c represents a testing compression factor, and τ represents a change point when the validation phase ends.
